(19) United States
(12) Patent Application Publication
(10) Pub. No.: US 2005/0147543 A1
(43) Pub. Date: Jul. 7, 2005

(54) Photocatalysis water-supply device

(76) Inventor: Pi Chion Lin, Taichung (TW)

Correspondence Address: TROXELL LAW OFFICE PLLC, SUITE1404, 5205 LEESBURG PIKE, FALLS CHURCH, VA, 22041, US

(21) Appl. No.: 10/752,033

(22) Filed: Jan. 7, 2004

(51) Int. Cl. B01J 19/12

(52) U.S. Cl. 422/186.3

(57) ABSTRACT

The present invention is a photocatalysis water purifying device that provides an excellent purging water quality feature. The outermost part of the device is equipped with a light-pervious cover; the inner part of the device has an ultraviolet tube. Furthermore, a photocatalysis membrane is clothed outside the light-pervious cover. Due to the direct application of the photocatalysis membrane on the ultra violet tube and the utilization of the silica gel to seal up the opening for water-resistance purposes, this device can be put in the water alone with the tube and thereby effectively provides the antibacterial and germ-eliminating functions based on the stimulation between violate-rays and photocatalysis. Moreover, the device can be used together with an air-supplier to assist the chemical reaction of photocatalysis.

### FIELD OF THE INVENTION

The device is designed for the purpose of purifying water quality through the installation of the photocatalysis device on the aquarium, water tank, and water towers. It is equipped with an ultra violet tube, a light-pervious cover, and photocatalysis membrane that would be clothed outside the cover. Also, the device can make use of applying photocatalysis directly on the ultra violet tube and sealed up the power supply with silica gel. Then, it is soaked in the water, which will generate the feature of antibacterial and germs elimination through the stimulation between the violate-ray and photocatalysis. An air pump can be added when necessary to boost the reactions of germ suppression and elimination.

### DESCRIPTION OF THE PRIOR ART

One should always prevent the exceeding level of bacteria contained in water for daily usage, no matter whether it is for washing or drinking. It is known that when water is exposed under room temperature for a certain amount of time, bacteria will begin to reproduce. In order to suppress the growth of bacteria or distinguish it, one usually adds an adequate amount of chemicals, such as chlorine or bactericide, in the water, or makes use of equipment such as an Ozone generator to achieve the same goal. However, it is not easy to control the adequate amount of chemicals added in the water and these will cause secondary damage to the human bodies. Besides, the expenses of installing the Ozone generator or alike is sometime costly and the generator is difficult to maintain. In conclusion, it is not a very desirable method in terms of ensuring the quality of water.

Therefore, after thorough analysis, the inventor developed this device based on the research on the photocatalysis's powerful antibacterial feature and thereby achieved the effectiveness of the germ suppression and elimination through the chemical reaction of catalysis and stimulation.

The device is equipped with an ultra violet tube, a light-pervious cover, and the photocatalysis membrane can be applied either on the outside of the cover or can be clothed directly on the ultra violet tube and the power supply terminal sealed up with silica gel. When used, it is put in the water, which will generate a chemical reaction stimulated by a violet-ray and catalysis in order to produce germ suppression and elimination effects; when operated, it can be used with the air auxiliary equipment to enhance the performance between the violate-ray and catalysis for the purpose of germ suppression and elimination.

So-called “catalysis” is an accelerant that can activate reactions. It does not take part in the chemical reaction and yet provides the advantageous transformation. Moreover, “photocatalysis” belongs to this special reaction and is generated from the illumination of a violet-ray or other light sources. Currently, the most advanced technique of photocatalysis is composed with material related to nano-size Titania particles.

The most widely used photocatalysis material is composed with Titania particles and water-adhesive material. When it is exposed under a violet-ray or other light source, an electron will be generated on the surface of the Titania, which can accelerate and decompose the hydroxide free radicals and super-oxidion to destroy the cytomembrane effectively. Furthermore, it can suppress the activation of viruses or bacteria and even eliminate germs. Therefore, photocatalysis has germ-suppression, germ-elimination, non-toxicity, deodorant, hydrofoil, and self-cleaning features

Photocatalysis is chemical residue generated though light which can decompose most toxic chemical substances and transform those into non-toxic substances. It is advantageous to the environment; hence it has become the most effective environmental protection product in the 21^{st} century.

When the photocatalysis reaction is exposed under the environment that is filled with oxygen, the simulation effect will be greatly improved. If air auxiliary equipment can be used alongside the invention, the stimulation effect will be more obvious. If used in an aquarium, the invention can replace the air pump independently.

### SUMMARY OF THE INVENTION

The present invention is a photocatalysis water purifying device that provides excellent purging water quality features. The outermost part of the device is equipped with a light-pervious cover; the inner part of the device has an ultraviolet tube. Furthermore, a photocatalysis membrane is clothed outside the light-pervious cover. Moreover, the device can be used together with an air-supplier to assist the chemical reaction of photocatalysis to achieve the features of germ-suppression, germ-elimination, non-toxicity, deodorant, hydrofoil, and self-cleaning.

### BRIEF DESCRIPTION OF DRAWINGS

FIG. 1 is a side view of the photocatalysis invention;

FIG. 2 is another side view of the photocatalysis invention when utilizing different types of lighting tubes;

FIG. 3 is a side view of the photocatalysis invention when operated with several lighting device on the same base;

FIG. 4 is still a side view of the invention equipped with an air pump device;

FIG. 5 is a side view of the same invention using a single-head purifying lighting tube;

FIG. 6 is another side view of the invention using a double head purifying lighting tube;

FIG. 7 is a side view of the invention when adding the air auxiliary equipment on the photocatalysis purifying tube;

FIG. 8 is an end view of the auxiliary object—a sucking disk C type fixture; and

FIG. 9 is a side view of the auxiliary object—a bolting C type fixture.

### DESCRIPTION OF THE PREFERRED EMBODIMENTS

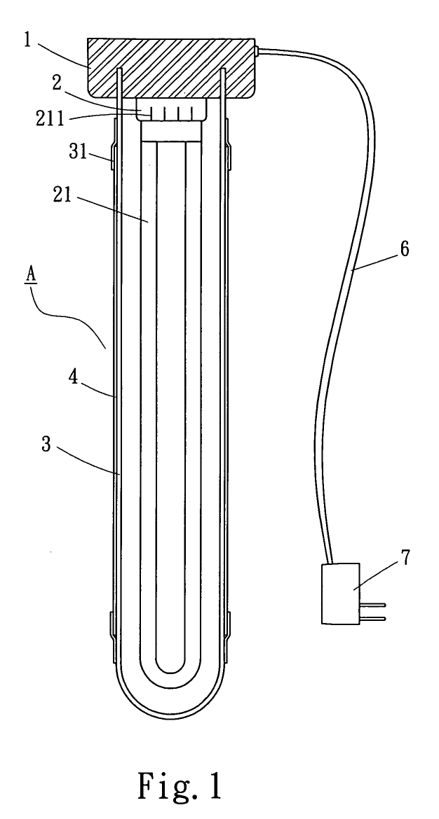

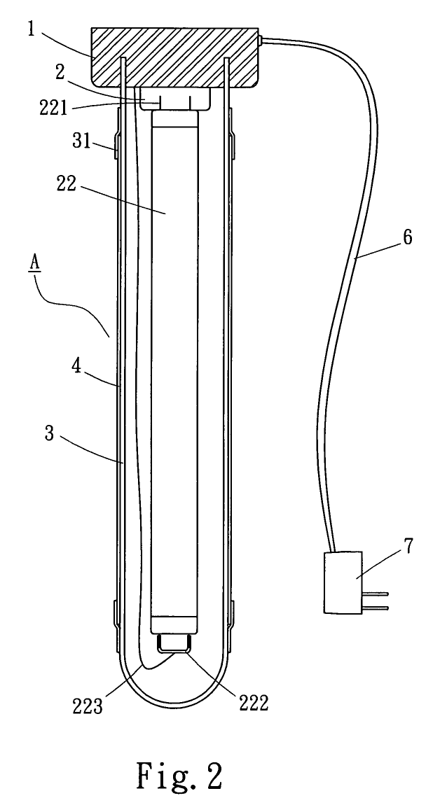

This invention is created and researched based on the chemical reaction of the photocatalysis. As shown in FIG. 1, the photocatalysis device (A) comprises a base (1), an electrode (2), a light-pervious cover (3), a photocatalysis membrane (4), a fixer (5), a power cord (6), and a stabilizer connector (7). The base (1) is equipped with one electrode stand (2) with either a one-head ultra violet tube (21) or a two-head ultra violet tube (22) as marked on the FIG. 2. The electrode points (211, 221) can be inserted directly to the terminals (222) and power supply cords (223). The applied tube is not restricted to ultra violet tubes as long as the power source can stimulate the catalysis reaction.

The electrode stand (2) on the base (1) can be sealed with a light-pervious cover (3). Regarding the light-previous cover (3), it is clothed with the heat-contracting tube (31) or other secure loop on the periphery to stable the photocatalysis membrane (4), which contains catalysis material of paper products, Teflon, textile products, fiber, or metal. The extension of the base (1) is one electric core (6), and the core terminal connects to an stabilizer connector (7) which can be plugged into the regular current plug.

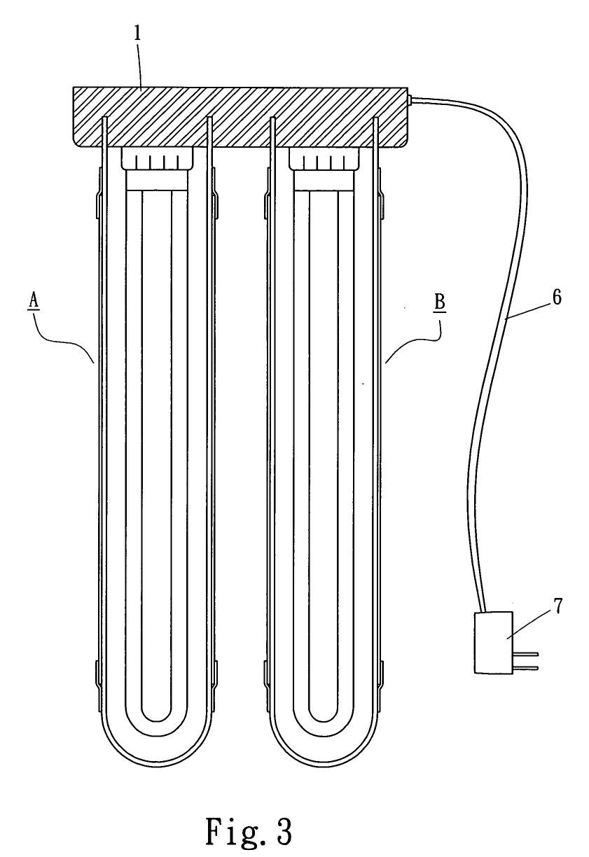

Referring to FIG. 3, the photocatalysis water-purifying invention can simultaneously install several photocatalysis devices (A, B) on the same base (1) to fit the capacity and effectiveness of the sink accordingly.

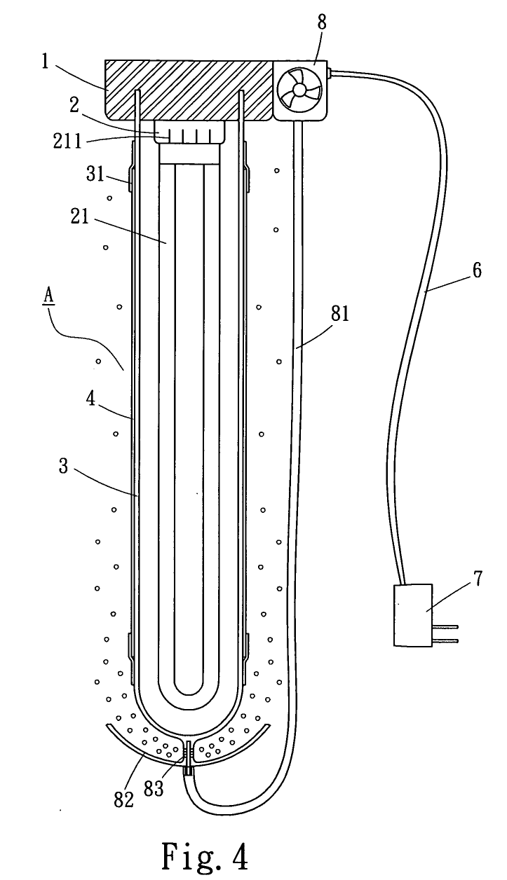

Referring to FIG. 4, this base (1) of the invention can install with an air pump (8) per unit. Through the pipeline (81), the air will be led to the light-pervious cover (3) and flow to the extending curved cover (82) on the bottom. Furthermore, through the penetrating hole (83), the air will follow the curved cover (82) to be led to the photocatalysis membrane (4) and enhance the catalysis and stimulating reactions under the circumstances of adding-in oxygen to promote the antibacterial features.

When the device operates under adding-in air pump (8), other than the base (1) and air pump (8), the rest will be soaked in the aquarium, water tank, or water towers and secured with the attached fixture (9).

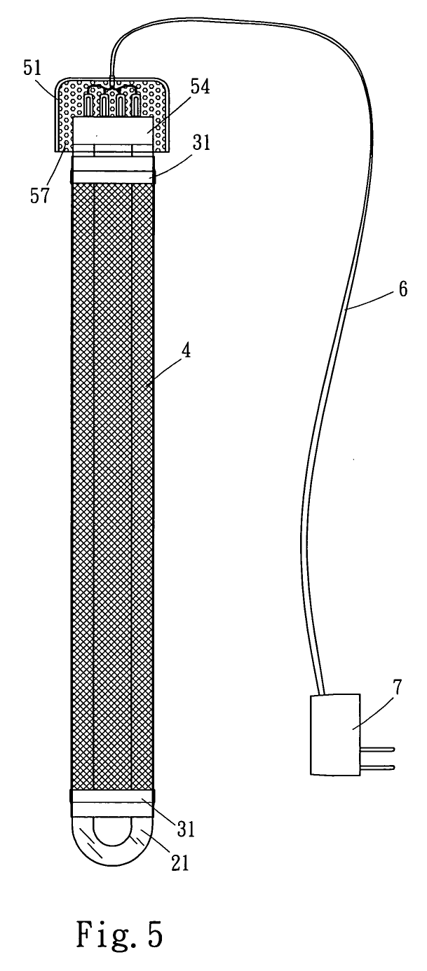

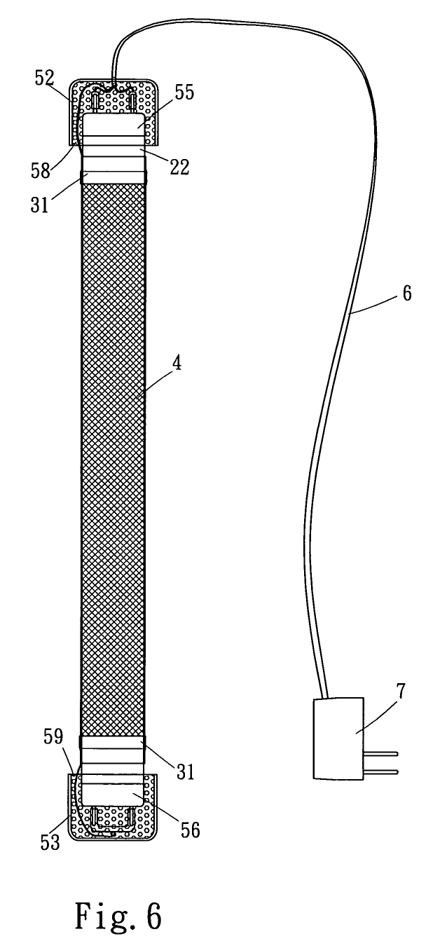

Referring to FIGS. 5 and 6, the device can use either one double-head violet tube (21) or one single-head violet tube (22) and add-in the photocatalysis membrane (4) on the peripheral of the device. Then, put the electric terminal into the sleeve (51, 52, 53), set the light bulb (54, 55, 56) inside the sleeve (51, 52, 53), and seal the openings with silica gel (57, 58, 59) for waterproofing. The silica gel is not restricted to use on this device as along as there is any sealant that can perform great air-tightness.

Either a double-head violet tube (21) or a single-head violet tube (22) mentioned above can add-in the photocatalysis membrane (3) on the peripheral, which can be secured by the head-contracting tube (31) or other secure loop on both ends of the photocatalysis membrane (3).

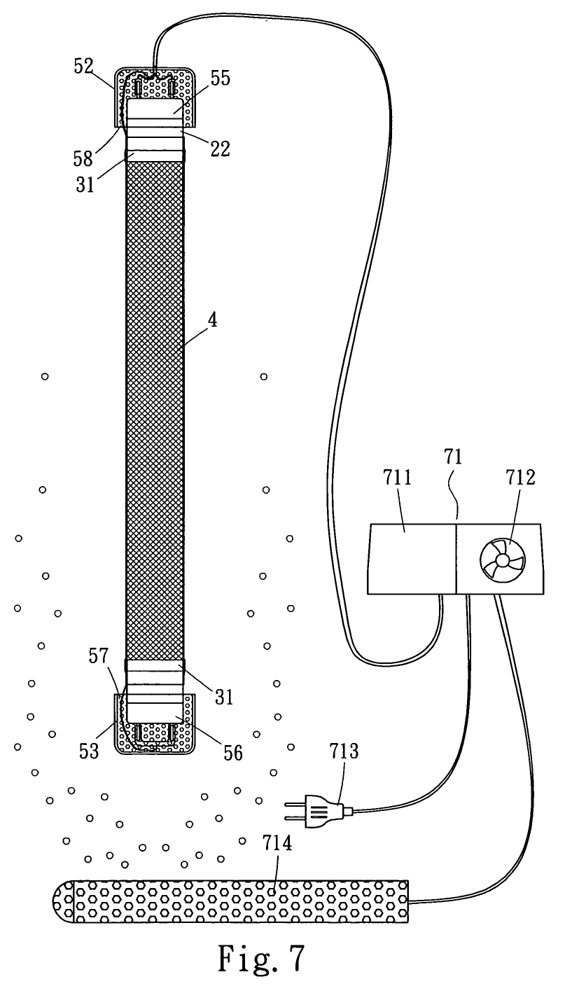

Referring to FIG. 7, the stabilizer connector (7) can be switch to air-supply auxiliary device (71), which contains the adapter (711), an air pump (712), and the electric plug (713). The air pump (712) is put into the water by the air-injecting stick (714), which will guide air near the photocatalysis membrane (3) in order to enhance the chemical reaction of catalysis and stimulation for promoting germ-suppression, germ-elimination, non-toxicity, deodorant, hydrofoil, and self-clean features.

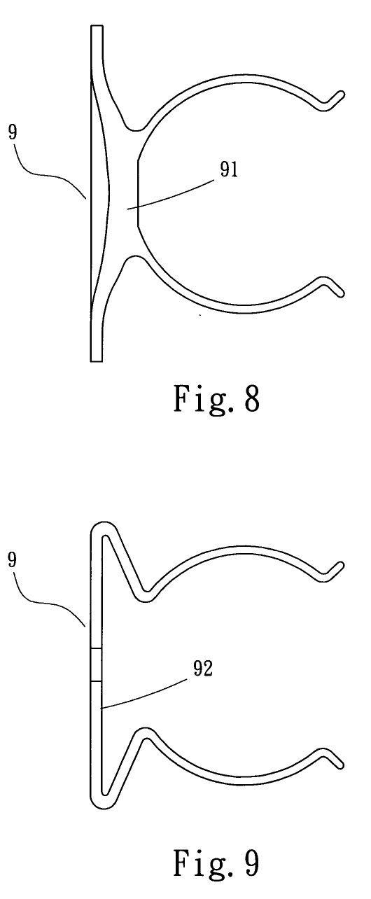

Other than the part of the base (1), when the device is operating, the parts, like the double-head violet tube (21) or the single-head violet tube (22), should be soaked into the aquarium, water tank, and water towers. Utilizing the attached fixture (9), as referring to in FIG. 8 and 9, such as a sucking disk C type stand (91) or a bolting C type (92), for adhering to the glossy wall or bolt inside the water sink. Utilizing the secure type of photocatalysis device (A) or the tube (51, 52, 53) to promote the simulation of the chemical reaction to achieve germ-suppression, germ-elimination, non-toxicity, deodorant, hydrofoil, and self-cleaning effects

1. A photocatalysis water purifying device including a base, an electrode stand, light-pervious cover, a photocatalysis membrane, a fixer, the power core, and a plug, an electrode, which can supply the power for either single-head violet tube or double-head violet tube set via the electrode point on the tube, is installed on the base, outside the electrode stand, the base would be sealed by a light-pervious cover, the heat-contraction tube or other fixture loop will have the light-catalysis membrane on the periphery of the cover, and one extension core provided a plug at the end will be connected to the base, when the device is soaked in the water, the water quality will be achieved the functions of germs-suppression, germs-elimination, non-toxicity, deodorant, hydrofoil, and self-clean.

2. The photocatalysis water purifying device as recited in claim 1, wherein an air pump can be mounted on the base and a curved cover can be set on the light-pervious cover; through a penetrated hole, air will be guided to the cover and be led to the photocatalysis membrane to boost the catalysis and stimulation reaction.

3. The photocatalysis water purifying device as recited in claim 1, wherein the device can also be equipped simultaneously with the several photocatalysis on the same base.

4. The photocatalysis water purifying device as recited in claim 1, wherein the device can be applied in another usage, the device can utilize either a single-head ultra violet tube or a double-head ultra violet tube and clothe with the photocatalysis membrane on the tubes, the device can put either the end of the electric core or the end of the tube into the sleeve, which should be sealed later with silicon gel for waterproofing, the electrode end will be connected with the plug of the adapter by the electric cord, the photocatalysis membrane is added on the periphery of either the single-head ultra violet tube or the double-head ultra violet tube through the head-contracted tube or either stable loop to secure both ends of the membrane.

5. The photocatalysis water purifying device and auxiliary equipment as recited in claim 4, wherein the stabilizer connector can be switch to an air-supply auxiliary device that contains the adapter, an air pump, and the electric plug. The air pump is put into the water by the air-injecting stick that will guide air near the photocatalysis membrane in order to enhance the chemical reaction of catalysis and stimulation.

6. The photocatalysis water purifying device and the auxiliary equipment as recited in claim 1, wherein the photocatalysis membrane contains the ingredients of paper products, Teflon, textile products, fiber, or mental.

7. The photocatalysis water purifying device and the auxiliary equipment as recited in claim 1, wherein the stand can equip with a sucking disk C type stand or a bolting C type stand for adhering either on the glossy wall or bolt inside the water sink.

8. The photocatalysis water purifying device and the auxiliary equipment as recited in claim 1, wherein the electric terminal and the power-supply core are affixed to the electrode end of the double-head ultra violet tube.

9. The photocatalysis water purifying device and the auxiliary equipment as recited in claim 1, wherein the applied tube is not restricted to an ultra violet tube as long as the power source can stimulate the catalysis reaction.

10. The photocatalysis water purifying device and the auxiliary equipment as recited in claim 4, wherein the photocatalysis membrane contains the ingredients of paper products, Teflon, textile products, fiber, or mental.

11. The photocatalysis water purifying device and the auxiliary equipment as recited in claim 4, wherein the stand can equip with a sucking disk C type stand or a bolting C type stand for adhering either on the glossy wall or bolt inside the water sink.

12. The photocatalysis water purifying device and the auxiliary equipment as recited in claim 4, wherein the electric terminal and the power-supply core are affixed to the electrode end of the double-head ultra violet tube.

13. The photocatalysis water purifying device and the auxiliary equipment as recited in claim 4, wherein the applied tube is not restricted to an ultra violet tube as long as the power source can stimulate the catalysis reaction.
